(19) United States
(12) Patent Application Publication
(10) Pub. No.: US 2008/0088534 A1
(43) Pub. Date: Apr. 17, 2008

(54) PLASMA DISPLAY DEVICE, DRIVING APPARATUS THEREOF, AND DRIVING METHOD THEREOF

(75) Inventor: Jin-Boo Son, Yongn-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/748,173

(22) Filed: May 14, 2007

(30) Foreign Application Priority Data
Oct. 17, 2006 (KR) 10-2006-0100899

(51) Int. Cl. G09G 3/28

(52) U.S. Cl. 345/60; 345/67

(57) ABSTRACT

A plasma display device includes a plurality of electrodes; and a switch having a first terminal connected to a power source to supply a sustain voltage that is applied to the plurality of electrodes in a sustain period, and having a second terminal connected to the plurality of electrodes. The switch maintains a voltage of the plurality of electrodes at the sustain voltage by turning on in the sustain period, and gradually increases a voltage of the plurality of electrodes from a positive first voltage to a second voltage that is a sum of the first voltage and the sustain voltage by repeatedly turning on and off in a portion of a reset period.

### CROSS-REFERENCE TO RELATED APPLICATIONS

This application claims the benefit of Korean Patent Application No. 2006-100899 filed on Oct. 17, 2006, in the Korean Intellectual Property Office, the disclosure of which is incorporated herein by reference in its entirety.

### BACKGROUND OF THE INVENTION

1. Field of the invention

An aspect of the invention relates to a plasma display device and a driving apparatus thereof having a simple circuit.

2. Description of the Related Art

A plasma display device is a flat panel display that displays characters or images using plasma generated by a gas discharge. In a plasma display panel of the plasma display device, tens to millions of discharge cells (hereinafter referred to as a “cell”) depending on the size of the plasma display panel are arranged in a matrix.

The plasma display device divides a frame into a plurality of subfields each having a grayscale weight value for driving the plasma display panel. The luminance of a cell is determined by the sum of the grayscale weight values of the subfields in which the cell emits light.

Each subfield includes a reset period, an address period, and a sustain period. The reset period is a period for initializing a wall charge state of a cell. The address period is a period for performing an address operation to select light emitting cells and non-light emitting cells among the cells of the plasma display panel. The sustain period is a period for displaying an image by performing a sustain discharge in a cell selected as a light emitting cell in the address period during a period corresponding to a weight value of a corresponding subfield.

In general, in a reset period, a weak discharge is generated between electrodes by applying a gradually decreasing voltage waveform to a scan electrode after applying a gradually increasing voltage waveform (hereinafter referred to as a “reset rising waveform”) to the scan electrode, thereby initializing a wall charge state of the cell. In a sustain period, by applying sustain discharge pulses with opposite phases to a scan electrode and a sustain electrode paired together and extending in a same direction, a sustain discharge is generated in a cell selected as a light emitting cell.

In a plasma display device according to the related art, a circuit for applying a reset rising waveform to the scan electrode circuit and a circuit for applying a sustain discharge pulse are implemented as separate circuits.

That is, a voltage (hereinafter referred to as a “reset rising voltage”) necessary for a reset rising waveform and a voltage (hereinafter referred to as a “sustain voltage”) necessary for a sustain discharge pulse are set to different voltage levels, and a power source for supplying the reset rising voltage and a power source for supplying the sustain voltage are implemented as separate power sources. Further, a switch for applying the reset rising voltage to the scan electrode and a switch for applying the sustain voltage to the scan electrode are implemented as separate switches.

Accordingly, in the plasma display device according to the related art, because a reset rising voltage and a sustain voltage are set to different voltage levels, an additional element should be provided to prevent a current path from being formed toward the power source for supplying the reset rising voltage or the power source for supplying the sustain voltage. Accordingly, there is a limitation on simplifying a circuit of the plasma display device.

The above information disclosed in this Background of the Invention section is only for enhancement of understanding of the background of the invention, and is not to be construed in any way that this information is prior art that was known by others in this country before the invention was made.

### SUMMARY OF THE INVENTION

An aspect of the invention is a plasma display device and a driving apparatus thereof having a simple circuit.

According to an aspect of the invention, a plasma display device includes a plurality of electrodes; a first switch having a first terminal connected to a first power source to supply a sustain voltage that is applied to the plurality of electrodes in a sustain period, and having a second terminal connected to the plurality of electrodes; an amplifier having a first power terminal to which a first voltage to turn on the first switch is applied, a second power terminal to which a second voltage to turn off the first switch is applied, an input terminal to which a control signal is input, and an output terminal to output the first voltage to turn on the first switch, or the second voltage to turn off the first switch, in response to the control signal; a first resistor having a first terminal connected to the first power terminal of the amplifier, the first resistor having a first resistance value; and a second switch having a first terminal connected to the first power terminal of the amplifier, the second switch being connected in parallel with the first resistor.

The plasma display device may further include a second resistor having a first terminal connected to the second switch so that the second resistor is connected in series with the second switch, and the series connection of the second resistor and the second switch is connected in parallel with the first resistor; and the second resistor may have a second resistance value smaller than the first resistance value.

The second terminal of the first switch may be a source of the first switch; the first switch may further have a gate; and the plasma display device may further include a third resistor having a first terminal connected to the input terminal of the amplifier; a fourth resistor connected between the output terminal of the amplifier and the gate of the first switch; and a fifth resistor connected between the gate of the first switch and the second terminal of the first switch that is the source of the first switch.

The first power terminal of the amplifier may be connected to a second power source to supply the first voltage; and the second power terminal of the amplifier may be connected to the second terminal of the first switch.

The first switch may further have a gate; the output terminal of the amplifier may be connected to the gate of the first switch; the amplifier may include an npn-type transistor having a collector connected to a junction point of the first resistor and the second switch via the first power terminal of the amplifier, an emitter connected to the gate of the first switch via the output terminal of the amplifier, and a base to which the control signal is applied via the input terminal of the amplifier; and a pnp-type transistor having a collector connected to the second terminal of the first switch via the second power terminal of the amplifier, an emitter connected to the gate of the first switch via the output terminal of the amplifier, and a base to which the control signal is applied via the input terminal of the amplifier; and the npn-type transistor and the pnp-type transistor may form a push-pull circuit.

The plasma display device may further include a diode having an anode connected to a second power source to supply the first voltage, and having a cathode connected to a junction point of the first resistor and the second switch.

The first switch may maintain a voltage of the plurality of electrodes at the sustain voltage by turning on in the sustain period, and may gradually increase a voltage of the plurality of electrodes from a positive third voltage to a fourth voltage that is a sum of the third voltage and the sustain voltage by repeatedly turning on and off in a portion of a reset period.

A current path including the second switch may be formed by turning on the second switch in the sustain period.

A current path including the first resistor may be formed by turning off the second switch in the portion of the reset period.

A period of the control signal in the portion of the reset period may be shorter than a period of the control signal in the sustain period.

According to an aspect of the invention, there is a driving apparatus of a plasma display device, the plasma display device including a plurality of electrodes, the driving apparatus including a first switch connected between the plurality of electrodes and a first power source to supply a sustain voltage that is applied to the plurality of electrodes in a sustain period, the first switch having a control terminal; and a driving circuit of the first switch. The driving circuit of the first switch may include an amplifier having a first power terminal to which a first voltage is applied, a second power terminal to which a second voltage is applied, an input terminal to which a control signal is applied, and an output terminal to output the first voltage or the second voltage in response to the control signal, the output terminal of the amplifier being connected to the control terminal of the switch; a first resistor connected between a second power source to supply the first voltage and the first power terminal of the amplifier; and a second switch and a second resistor connected in series with one another, the series connection of the second switch and the second resistor being connected in parallel with the first resistor between the second power source and the first power terminal of the amplifier. If the first voltage is output from the output terminal of the amplifier, the first switch may turn on. If the second voltage is output from the output terminal of the amplifier, the first switch may turn off. The first switch operates to apply the sustain voltage to the plurality of electrodes in the sustain period, and operates to apply a gradually increasing voltage to the plurality of electrodes in a portion of a reset period.

The driving apparatus may further include a diode having an anode connected to the second power source to block a current from flowing to the second power source.

The first switch may further have a first terminal connected to the plurality of electrodes, and the driving apparatus may further include a third resistor having a first terminal connected to the input terminal of the amplifier; a fourth resistor connected between the output terminal of the amplifier and the control terminal of the first switch; and a fifth resistor connected between the first terminal of the first switch that is connected to the plurality of electrodes, and the control terminal of the first switch.

The first switch may further have a first terminal connected to the plurality of electrodes; the driving apparatus may further include a capacitor connected between the first power terminal of the amplifier and the second power terminal of the amplifier; and the second power terminal of the amplifier may be connected to the first terminal of the first switch that is connected to the plurality of electrodes.

The first switch may further have a first terminal connected to the plurality of electrodes; and the amplifier may be a push-pull circuit including an npn-type transistor having a collector connected to a junction point of the first resistor and the second resistor via the first power terminal of the amplifier, an emitter connected to the output terminal of the amplifier, and a base to which the control signal is applied via the input terminal of the amplifier; and a pnp-type transistor having a collector connected to the first terminal of the first switch via the second power terminal of the amplifier, an emitter connected to the output terminal of the amplifier, and a base to which the control signal is applied via the input terminal of the amplifier.

The first switch may operate to gradually increase a voltage of the plurality of electrodes from a positive third voltage to a fourth voltage that is a sum of the third voltage and the sustain voltage by repeatedly turning on and off in the portion of the reset period.

A first current path including the second power source, the second switch, the second resistor, and the first power terminal of the amplifier may be formed by turning on the second switch in the sustain period; a second current path including the second power source, the first resistor, and the first power terminal of the amplifier may be formed by turning off the second switch in the portion of the reset period; and a current flowing in the first current path may be greater than a current flowing in the second current path.

A period of the control signal in the portion of the reset period may be shorter than a period of the control signal in the sustain period.

According to an aspect of the invention there is a driving method of a plasma display device, the plasma display device including a plurality of electrodes, and a first switch connected between the plurality of electrodes and a first power source to supply a sustain voltage to be applied to the plurality of electrodes in a sustain period, the first switch having a control terminal, the driving method including applying a first current to the control terminal of the first switch in the sustain period; and discontinuously applying a second current having a current value smaller than a current value of the first current to a control terminal of the first switch in a of a reset period.

The applying of a first current may include continuously applying the first current to the control terminal of the first switch in the sustain period.

The plasma display device may further include a first resistor; and a second resistor having a resistance value smaller that a resistance value of the first resistor; a path of the first current may include the first resistor; and a path of the second current may include the second resistor.

The discontinuously applying of a second current may cause a voltage of the plurality of electrodes to gradually increase from a positive first voltage to a second voltage that is a sum of the first voltage and the sustain voltage.

According to an aspect of the invention, a plasma display device includes a plurality of electrodes; a switch having a first terminal, a second terminal, and a control terminal, the first terminal being connected to a sustain voltage source to supply a sustain voltage to be applied to the electrodes in a sustain period of the plasma display device, the second terminal being connected to the electrodes; and a driving circuit to apply a first current having a first current value to the control terminal of the switch in the sustain period, and to apply a second current having a second current value less than the first current value to the control terminal of the switch during a portion of a reset period of the plasma display device.

The driving circuit may apply the first current to the control terminal of the switch in the sustain period to control the switch to turn on in the sustain period to maintain a voltage of the electrodes at the sustain voltage; and may discontinuously apply the second current to the control terminal of the switch in the portion of the reset period to control the switch to repeatedly turn on and off in the portion of the reset period to gradually increase a voltage of the electrodes from a positive first voltage to a second voltage that is a sum of the positive first voltage and the sustain voltage.

Additional aspects and/or advantages of the invention will be set forth in part in the description that follows and, in part, will be obvious from the description, or may be learned by practice of the invention.

### BRIEF DESCRIPTION OF THE DRAWINGS

The above and/or other aspects and advantages of the invention will become apparent and more readily appreciated from the following description of embodiments of the invention, taken in conjunction with the accompanying drawings of which:

FIG. 1 is a schematic diagram of a plasma display device according to an aspect of the invention;

FIG. 2 is a diagram of driving waveforms of the plasma display device of FIG. 1 according to an aspect of the invention;

FIG. 3 is a schematic diagram of a circuit of a scan electrode driver 400 of FIG. 1 according to an aspect of the invention;

FIG. 4 is a conceptual schematic diagram of a gate driving circuit 440 of a switch Ysr for connecting a power source for supplying a sustain voltage to a scan electrode in the circuit of FIG. 3 according to an aspect of the invention;

FIG. 5 is a detailed schematic diagram of the gate driving circuit 440 of the switch Ysr of FIG. 3 according to an aspect of the invention;

FIG. 6 is a diagram of a current path formed in the gate driving circuit 440 of FIG. 5 in a sustain period according to an aspect of the invention;

FIG. 7 is a diagram of a control signal Din and a source voltage of the switch Ysr of the gate driving circuit 440 of FIG. 5 in a rising period of a reset period according to an aspect of the invention; and

FIG. 8 is a diagram of a current path formed in the gate driving circuit 440 of FIG. 5 when the control signal Din is at a high level in the rising period of the reset period according to an aspect of the invention.

### DETAILED DESCRIPTION OF THE EMBODIMENTS

Reference will now be made in detail to embodiments of the invention, examples of which are shown in the accompanying drawings, wherein like reference numerals refer to like elements throughout. The embodiments are described below in order to explain the invention by referring to the figures.

In this specification, when it is said that any part is “connected” to another part, this indicates that the part is either “directly connected” to the other part, or “electrically connected” to the other part through at least one intermediate part. Further, when it is said that any part “includes” another constituent element, this indicates that the part may further include other constituent elements insofar as there is no statement to the contrary.

Now, a plasma display device and a driving apparatus thereof according to an aspect of the invention will be described in detail with reference to the drawings.

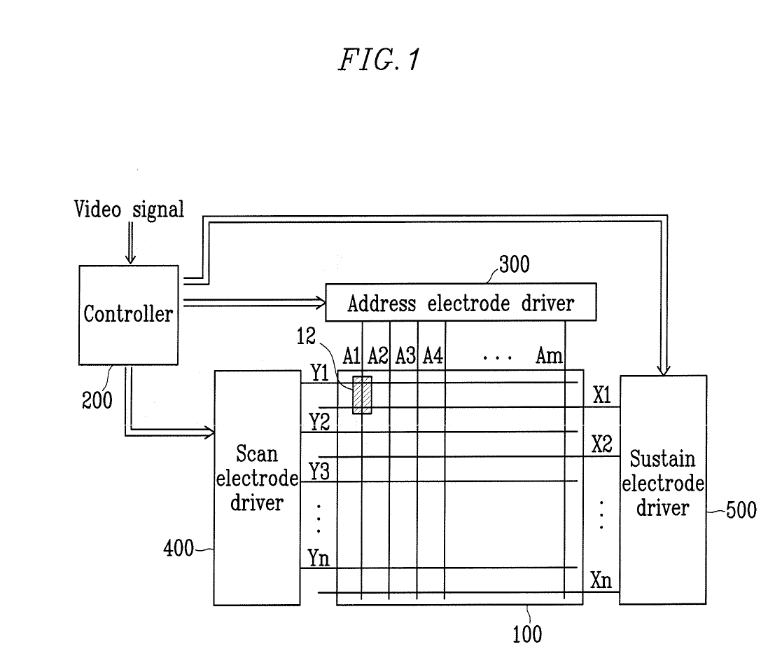

FIG. 1 is a schematic diagram of a plasma display device according to an aspect of the invention.

As shown in FIG. 1, a plasma display device according to an aspect of the invention includes a plasma display panel (PDP) 100, a controller 200, an address electrode driver 300, a scan electrode driver 400, and a sustain electrode driver 500. The PDP 100 includes a plurality of address electrodes A1-Am (hereinafter referred to as an “A electrode”) that extend in a column direction, and a plurality of sustain electrodes X1-Xn (hereinafter referred to as an “X electrode”) and a plurality of scan electrodes Y1-Yn (hereinafter referred to as a “Y electrode”) that extend in a row direction. The Y electrodes Y1-Yn and the X electrodes X1-Xn are arranged in pairs, with each pair including one Y electrode and one X electrode adjacent to the one Y electrode. A discharge cell 12 is formed at each intersection of one pair of one Y electrode and one adjacent X electrode, and one A electrode.

The controller 200 receives a video signal from outside the plasma display device, and outputs an address electrode driving control signal, a sustain electrode driving control signal, and a scan electrode driving control signal. The controller 200 divides a frame into a plurality of subfields each having a grayscale weight value for driving the plasma display panel 100.

The address electrode driver 300 receives an address electrode driving control signal from the controller 200 and applies a signal for selecting a discharge cell to be turned on to each of the A electrodes A1-Am. The sustain electrode driver 500 receives a sustain electrode driving control signal from the controller 200 and applies a driving voltage to the X electrodes X1-Xn. The scan electrode driver 400 receives a scan electrode driving control signal from the controller 200 and applies a driving voltage to the Y electrodes Y1-Yn.

Driving waveforms of a plasma display device according to an aspect of the invention will now be described. Hereinafter, for convenience, only driving waveforms that are applied to the Y electrode, the X electrode, and the A electrode forming one cell will be described.

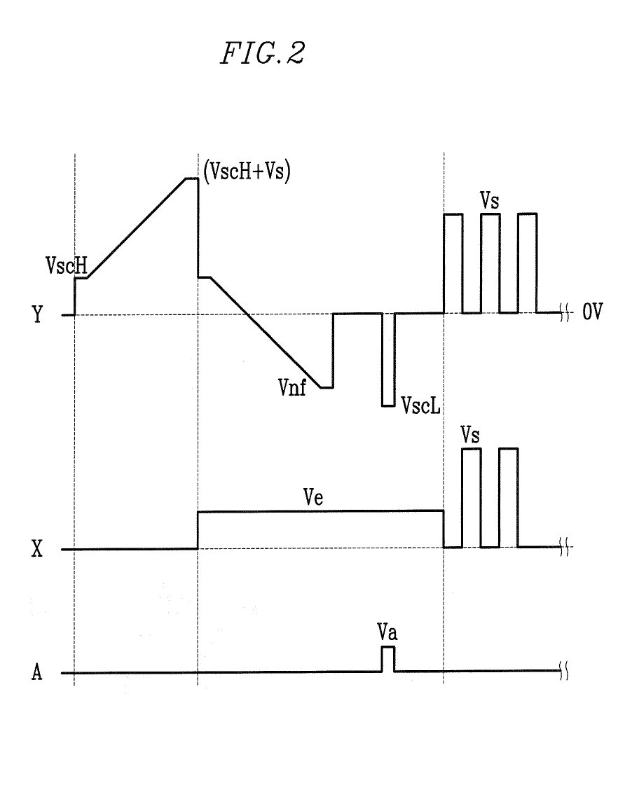

FIG. 2 is a diagram of driving waveforms of the plasma display device of FIG. 1 according to an aspect of the invention.

As shown in FIG. 2, in a rising period of a reset period, in a state where a reference voltage (“0V” in FIG. 2 and hereinafter referred to as a “0V voltage”) is applied to the A electrode and the X electrode, a voltage waveform (hereinafter referred to as a “reset rising waveform”) gradually increasing from a VscH voltage to a (VscH+Vs) voltage is applied to the Y electrode. As the reset rising waveform is being applied to the Y electrode, as a voltage difference between the Y electrode and the X electrode, and between the Y electrode and the A electrode, becomes greater than a voltage (hereinafter referred to as a “discharge firing voltage”) at which a discharge starts, a feeble discharge (hereinafter referred to as a “weak discharge”) is generated between the Y electrode and the X electrode, and between the Y electrode and the A electrode. Accordingly, a (−) wall charge is formed on the Y electrode and a (+) wall charge is formed on the X electrode and the A electrode by the weak discharge that is generated by the reset rising waveform that is applied to the Y electrode.

In a falling period of a reset period, in a state where the 0V voltage and a bias voltage (“Ve voltage” in FIG. 2 and hereinafter referred to as a “Ve voltage”) are applied to the A electrode and the X electrode, respectively, a voltage waveform (hereinafter referred to as a “reset falling waveform”) gradually decreasing from a VscH voltage to a Vnf voltage is applied to the Y electrode. A weak discharge is generated between the Y electrode and the X electrode, and between the Y electrode and the A electrode, while the reset falling waveform is applied to the Y electrode, whereby the (−) wall charge that was formed on the Y electrode and the (+) wall charge that was formed on the X electrode and the A electrode are erased. In general, a magnitude of a (Vnf-Ve) voltage is set around a discharge firing voltage Vfxy (not shown in the drawings) between the Y electrode and the X electrode. Accordingly, a wall voltage between the Y electrode and the X electrode becomes almost 0V, so that a cell in which an address discharge is not generated in an address period can be prevented from misfiring in a sustain period.

Although not shown in FIG. 2, a reset falling waveform may be a voltage waveform to which the VscH voltage is applied, and to which the 0V voltage is then applied, and that then gradually decreases from the 0V voltage to the Vnf voltage at the same slope shown in FIG. 2. Accordingly, a time that is allocated to a falling period of the reset period decreases, thereby improving a contrast. Since the slope of this reset falling waveform is not steeper than the slope shown in FIG. 2, generation of a strong discharge can be prevented.

In an address period, in order to select discharge cells to be turned on, in a state where the Ve voltage is applied to the X electrode, a scanning voltage (“VscL voltage” in FIG. 2 and hereinafter referred to as a “VscL voltage”) is sequentially applied to the plurality of Y electrodes. As the VscL voltage is sequentially applied to each of the Y electrodes an address voltage (“Va voltage” in FIG. 2 and hereinafter referred to as a “Va voltage”) is applied to the A electrode passing through a discharge cell to be selected to be turned on among a plurality of discharge cells in which the VscL voltage is being applied to the Y electrode. Accordingly, an address discharge is generated between the A electrode to which the Va voltage is applied and the Y electrode to which the VscL voltage is applied, and between the Y electrode to which the VscL voltage is applied and the X electrode to which the Ve voltage is applied, whereby a (+) wall charge is formed on the Y electrode and a (−) wall charge is formed on the A electrode and the X electrode. The VscL voltage may be set to be equal to or lower than the Vnf voltage. Although not shown in FIG. 2, a non-scan voltage higher than the VscL voltage is applied to at least one Y electrode to which the VscL voltage is not applied, and the 0V voltage is applied to the A electrode of an unselected discharge cell. Such a non-scan voltage may be set to a VscH+VscL level.

In a sustain period, a sustain voltage (“Vs voltage” in FIG. 2 and hereinafter referred to as a “Vs voltage”) and the 0V voltage are applied to the Y electrode and the X electrode with opposite phases, and thus a sustain discharge is generated between the Y electrode and the X electrode. That is, a process of simultaneously applying the 0V voltage to the X electrode while applying the Vs voltage to the Y electrode and a process of simultaneously applying the Vs voltage to the X electrode while applying the 0V voltage to the Y electrode are repeated a number of times corresponding to a grayscale weight value of a current subfield.

In FIG. 2, for brevity of description, a reset rising waveform or a reset falling waveform that is applied to the Y electrode in a reset period is shown in a ramp waveform form. However, in aspects of the invention, the reset rising waveform or the reset falling waveform may be any gradually increasing or decreasing waveform, such as an RC waveform, or a waveform that is floated while gradually increasing (or decreasing).

Next, in the scan electrode driver 400 for generating a driving waveform of the Y electrode shown in FIG. 2, an aspect of the invention that has a simple circuit will be described in detail.

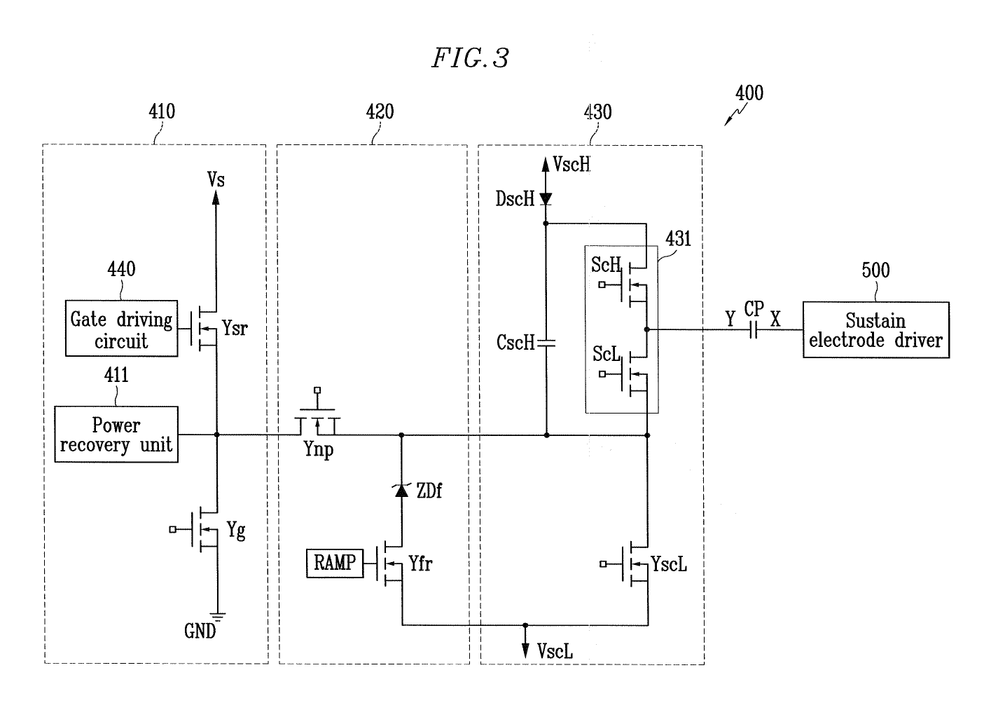

FIG. 3 is a schematic diagram of a circuit of the scan electrode driver 400 of FIG. 1 according to an aspect of the invention. Hereinafter, a switch is shown as a n-channel field effect transistor (FET) having a body diode (not shown), but this is only an example. In aspects of the invention, the switch may be replaced with another element that can perform a function equal or similar to an n-channel FET. Further, in FIG. 3, a capacitive component that is formed by the X electrode and the Y electrode is referred to as a panel capacitor Cp.

As shown in FIG. 3, the scan electrode driver 400 includes a sustain driver 410, a reset driver 420, and a scan driver 430.

The sustain driver 410 includes a power recovery unit 411, a switch Ysr, and a switch Yg. The sustain driver 410 alternately applies a Vs voltage and a 0V voltage to the Y electrode in a sustain period.

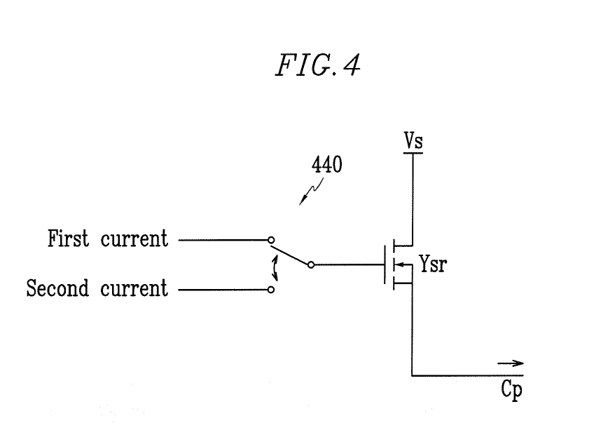

In the sustain driver 410, the power recovery unit 411 includes a power recovery capacitor, a power recovery inductor, a switch for forming a rising path, and a switch for forming a falling path (none of which are shown in FIG. 4). The power recovery capacitor charges to a voltage (e.g., a “Vs/2 voltage”) between the Vs voltage and the 0V voltage. If a switch for forming a rising path or a falling path is turned on, a LC resonance current path is formed between the power recovery capacitor, the power recovery inductor, and the panel capacitance Cp, thereby increasing or decreasing a voltage of the panel capacitance Cp. The power recovery unit 411 is not directly related to aspects of the invention, and thus a further description of the power recovery unit 411 will be omitted.

The switch Ysr is connected between a Vs power source for supplying the Vs voltage and the Y electrode, and the switch Yg is connected between a GND power source for supplying the 0V voltage and the Y electrode. In the sustain period, if the switch Ysr is turned on, the Vs voltage is applied to the Y electrode, and if the switch Yg is turned on, the 0V voltage is applied to the Y electrode.

Further, the switch Ysr operates to apply a gradually increasing reset rising waveform to the Y electrode in a rising period of a reset period. That is, a gate driving circuit 440 of the switch Ysr for applying a driving voltage to a gate of the switch Ysr gradually increases a source voltage of the switch Ysr up to the Vs voltage by repeatedly turning the switch Ysr on and off in the rising period of the reset period.

The reset driver 420 includes switches Ynp and Yfr, and a zener diode ZDf. The reset driver 420 applies a reset falling waveform to the Y electrode in a falling period of the reset period.

The switch Yfr is connected between a VscL power source for supplying the VscL voltage and the zener diode ZDf, and the zener diode ZDf is connected between the Y electrode and the switch Yfr. That is, an anode of the zener diode ZDf is connected to the switch Yfr, and a cathode of the zener diode ZDf is connected to the Y electrode. However, the positions of the zener diode ZDf and the switch Yfr can be interchanged. Accordingly, in a falling period of a reset period, a cathode voltage of the zener diode ZDf gradually decreases from the VscH voltage to the Vnf voltage which is a breakdown voltage of the zener diode ZDf through a turn-on operation of the switch Yfr controlled by a driving circuit labeled “RAMP.”

A drain of the switch Ynp is connected to a drain of the switch Yg, and a source of the switch Ynp is connected to a cathode of the zener diode ZDf. The switch Ynp prevents a current path from being formed toward a GND power source by being turned off while a voltage having a level lower than the 0V voltage is being applied to the Y electrode.

The scan driver 430 includes a selection circuit 431, a diode DscH, a capacitor CscH, and a switch YscL. The scan driver 430 sequentially applies a YscL voltage to the plurality of Y electrodes Y1-Yn and applies a non-scan voltage to the remaining Y electrodes to which the VscL voltage is not applied.

The selection circuit 431 includes a switch ScH and a switch ScL. The switch ScH is connected between the VscH power source for supplying the VscH voltage and the Y electrode, and the switch ScL is connected between the VscL power source for supplying the VscL voltage and the Y electrode. FIG. 3 shows only the selection circuit 431 that is connected to one Y electrode. However, selection circuits corresponding to each of the plurality of Y electrodes are connected to the plurality of Y electrodes, and these selection circuits including the selection circuit 431 are generally provided in an IC form.

An anode of the diode DscH is connected to the VscH power source, and a cathode of the diode DscH is connected to the switch ScH. The diode DscH having the above connection forms a current path from the VscH power source to the Y electrode when the switch ScH is turned on, prevents a current from flowing toward the VscH power source, and prevents an overcharge of the VscH power source.

A first terminal of the switch YscL is connected to the VscL power source, and a second terminal of the switch YscL is connected to the switch ScL of the selection circuit. The capacitor CscH is connected between the VscH power source and a GND power source. That is, a first terminal of the capacitor CscH is connected to a junction point of the diode DscH and the switch ScH, and a second terminal of the capacitor CscH is connected to a junction point of the switch Ynp, the zener diode ZDf, the switch ScL, and the switch YscL, and the diode DscH, the capacitor CscH, the switch Ynp, and the switch Yg are connected in series with each other between the VscH power source and the GND power source. The capacitor CscH is charged to the VscH voltage by turning on the switch Yg and the switch Ynp at the initial driving of the plasma display device.

Next, the gate driving circuit 440 that is connected to the gate of the switch Ysr, which controls the switch Ysr to apply a reset rising waveform to the Y electrode in the rising period of the reset period, and controls the switch Ysr to apply a sustain voltage to the Y electrode in a sustain period, will be described.

FIG. 4 is a conceptual schematic diagram of the gate driving circuit 440 of the switch Ysr for connecting the power source for supplying the sustain voltage to a scan (Y) electrode in the circuit of FIG. 3 according to an aspect of the invention.

According to an aspect of the invention, the switch Ysr that is connected between a Vs power source for supplying the sustain voltage and the Y electrode applies the Vs voltage to the Y electrode by turning on in the sustain period, and applies a reset rising waveform gradually increasing by the Vs voltage to the Y electrode by repeatedly turning on and off in rising period of the reset period. Whether the switch Ysr operates to apply the Vs voltage or operates to apply a reset rising waveform is determined by a current that is applied to a control terminal of the switch Ysr. The switch Ysr is shown as an n-channel FET in FIG. 4, and in this case, a control terminal of the switch Ysr is a gate of the n-channel FET.

That is, as shown in FIG. 4, the gate driving circuit 440 of the switch Ysr applies a first current or a second current to a control terminal of the switch Ysr. When the first current or the second current is applied to the control terminal of the switch Ysr, the switch Ysr is turned on.

For example, it is assumed that the first current has a greater current value than the second current, and the first current is continuously applied to the control terminal of the switch Ysr, but the second current is discontinuously applied to the control terminal of the switch Ysr.

In this case, the first current is applied to the control terminal of the switch Ysr in the sustain period, thereby completely turning on the switch Ysr.

However, in the rising period of the reset period, by discontinuously applying the second current to the control terminal of the switch Ysr, a turn-on and turn-off duty ratio of the switch Ysr becomes lower than a turn-on and turn-off duty ratio of the switch Ysr in the sustain period, whereby the switch Ysr is not completely turned on in the rising period of the reset period. Accordingly, in the rising period of the reset period, while the switch Ysr repeatedly turns on and off, a voltage of the Y electrode repeats a process of rising, sustaining, and rising. Accordingly, if the second current is applied to the switch Ysr, a voltage of the Y electrode rises at a slope that is lower than a slope at which the voltage of the Y electrode rises when the first current is applied to the control terminal of the switch Ysr.

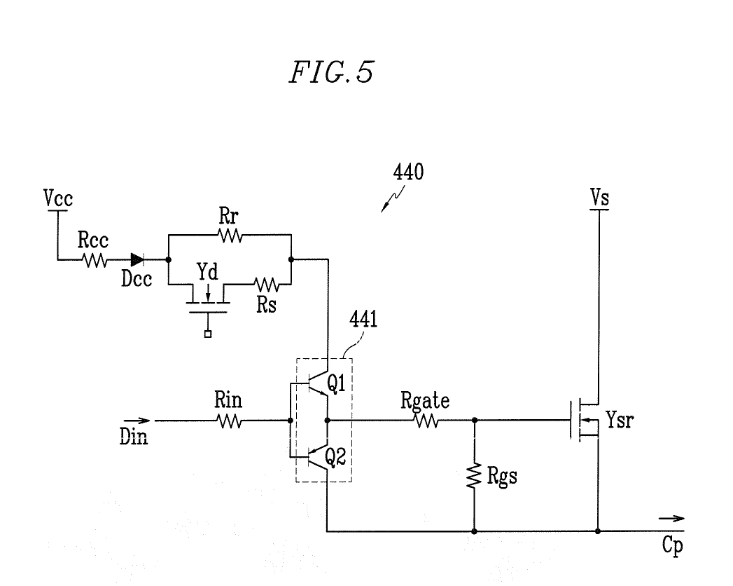

FIG. 5 is a detailed schematic diagram of the gate driving circuit 440 of the switch Ysr of FIG. 3 according to an aspect of the invention.

As shown in FIG. 5, the gate driving circuit 440 (hereinafter referred to as a “gate driving circuit”) of the switch Ysr includes a push-pull circuit 441, a switch Yd for determining a driving mode of the switch Ysr, resistors Rr, Rs, Rgate, Rin, and Rgs, and a diode Dcc, and may also include a resistor Rcc.

The push-pull circuit 441 includes an npn-type transistor Q1 and a pnp-type transistor Q2. Each of the transistor Q1 and the transistor Q2 has a collector, an emitter, and a base, and turns on or turns off in accordance with a voltage that is applied to the base. A high level power source (“Vcc” in FIG. 5 and hereinafter referred to as a “Vcc power source”) for supplying a high level voltage (e.g., a Vcc voltage) is connected to the collector of the npn-type transistor Q1, and a source of the switch Ysr is connected to the collector of the pnp-type transistor Q2.

According to a control signal Din that is applied to the bases of the transistor Q1 and the transistor Q2, the transistor Q1 is turned on and the transistor Q2 is turned off, or the transistor Q1 is turned off and the transistor Q2 is turned on. If the transistor Q1 is turned on and the transistor Q2 is turned off, a high level voltage that is applied to the collector of the transistor Q1 is applied to the gate of the switch Ysr. However, if the transistor Q2 is turned on and the transistor is turned off, a low level voltage that is applied to the collector of the transistor Q2 is applied to the gate of the switch Ysr.

A first terminal of the resistor Rin is connected to the bases of the transistor Q1 and the transistor Q2, and the control signal Din is applied to a second terminal of the resistor Rin. When the control signal Din is applied to the second terminal of the resistor Rin, the resistor Rin determines a magnitude of a current flowing to the bases of the transistor Q1 and the transistor Q2.

The resistor Rgate is connected between the emitters of the transistor Q1 and the transistor Q2 through which an output signal of the push-pull circuit 441 is output and the gate of the switch Ysr, and determines a magnitude of a current flowing to the gate of the switch Ysr.

The resistor Rgs is connected between the source of the switch Ysr and the nate of the switch Ysr, and prevents a gate voltage of the switch Ysr from abruptly changing according to a source voltage of the switch Ysr, thereby preventing an erroneous operation of the switch Ysr.

The resistor Rr is connected between the Vcc power source and the collector of the transistor Q1, and the resistor Rs is connected in parallel with the resistor Rr between the Vcc power source and the collector of the transistor Q1. A switch Yd is connected in series with either the resistor Rr (not shown in FIG. 5) or the resistor Rs (as shown in FIG. 5) between the Vcc power source and the collector of the transistor Q1, and determines whether a current path between the Vcc power source and the transistor Q1 includes the resistor Rr or the resistor Rs. The switch Yd is shown as a n-channel FET having a body diode (not shown), but this is only an example. In aspects of the invention, the switch Yd can be replaced with another element that can perform a function equal or similar to the n-channel FET.

That is, as shown in FIG. 5, if the switch Yd is connected in series with the resistor Rs, and the transistor Q1 is turned on and the switch Yd is turned off, a current path including the Vcc power source, the resistor Rr, and the transistor Q1 is formed. However, if the transistor Q1 and the switch Yd are turned on, a current path including the Vcc power source, the switch Yd, the resistor Rs, and the transistor Q1 is formed. Although theoretically some current will also flow through the resistor Rr in this situation, the resistance value of the resistor Rr is sufficiently greater than the resistance value of the resistor Rs so that the current flowing through the resistor Rr can be ignored.

Although not shown in FIG. 5, if the switch Yd is connected in series with the resistor Rr instead of the resistor Rs between the Vcc power source and the collector of the transistor Q1, a current path including the Vcc power source, the switch Yd, the resistor Rr, and the transistor Q1 is formed if the transistor Q1 and the switch Yd are turned on. However, if the transistor Q1 is turned on and the switch Yd is turned off, a current path including the Vcc power source, the resistor Rs, and the transistor Q1 is formed. Although theoretically some current will also flow through the resistor Rs in this situation, the resistance value of the resistor Rs is sufficiently greater than the resistance value of the resistor Rr so that the current flowing through the resistor Rs can be ignored.

When a current path including the resistor Rr is formed, the resistor Rr has a resistance value of more than several tens of Q so that a time between a turn-on and turn-off operation of the switch Ysr is lengthened as a parasitic capacitance (not shown in FIG. 5, and hereinafter referred to as a “capacitor Cgs”) between the gate and the source of the switch Ysr slowly charges to a voltage greater than a threshold voltage VT of the switch Ysr.

An anode of the diode Dcc is connected to the Vcc power source and a cathode of the diode Dcc is connected to the resistor Rr, and when a source voltage of the switch Ysr is higher than a voltage supplied from the Vcc power source, a current path flowing to the Vcc power source is blocked. A resistor Rcc coupled between the diode Dcc and the Vcc power source may be employed.

Operation of the gate driving circuit 440 of the switch Ysr in the sustain period and the rising period of the reset period will now be described.

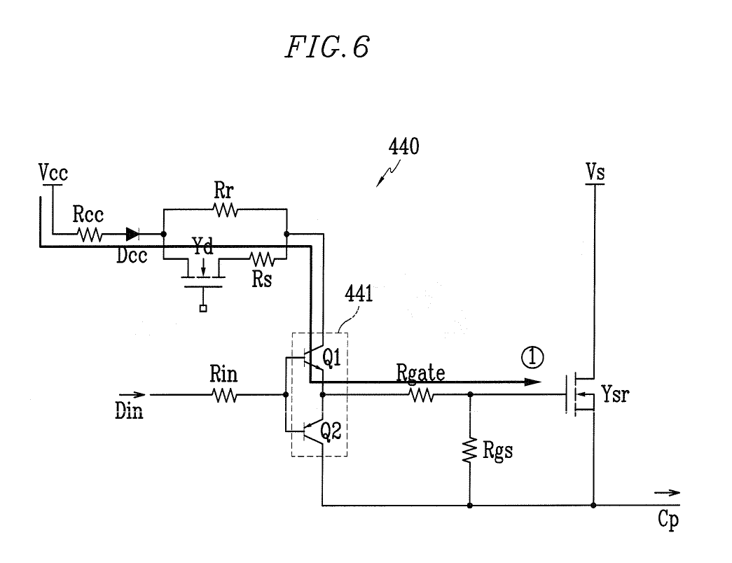

FIG. 6 is a diagram of a current path formed in the gate driving circuit 440 of FIG. 5 in the sustain period according to an aspect of the invention.

In the sustain period, the switch Yd is turned on and a high level of the control signal Din is applied to the push-pull circuit 441. Accordingly, a current path \textcircled{1} including the Vcc power source, the resistor Rcc, the diode Dcc, the switch Yd, the resistor Rs, the transistor Q1, and the resistor Rgate is formed. A current flowing through the current path \textcircled{1} charges the capacitor Cgs (the parasitic capacitance referred to above) between the gate and the source of the switch Ysr, thereby increasing a voltage of the capacitor Cgs. When the voltage of the capacitor Cgs becomes greater than the threshold voltage VT of the switch Ysr, the switch Ysr turns on and applies the Vs voltage to the Y electrode. A resistance value of the resistor Rs is set to be comparatively small so that a time it takes for the capacitor Cgs to charge up to a voltage that is greater than the threshold voltage VT is comparatively short.

Further, if a low level of the control signal Din is applied to the push-pull circuit 441, a transistor Q2 is turned on, and the voltage of the capacitor Cgs between the gate and the source of the switch Ysr is discharged, thereby turning the switch Ysr off.

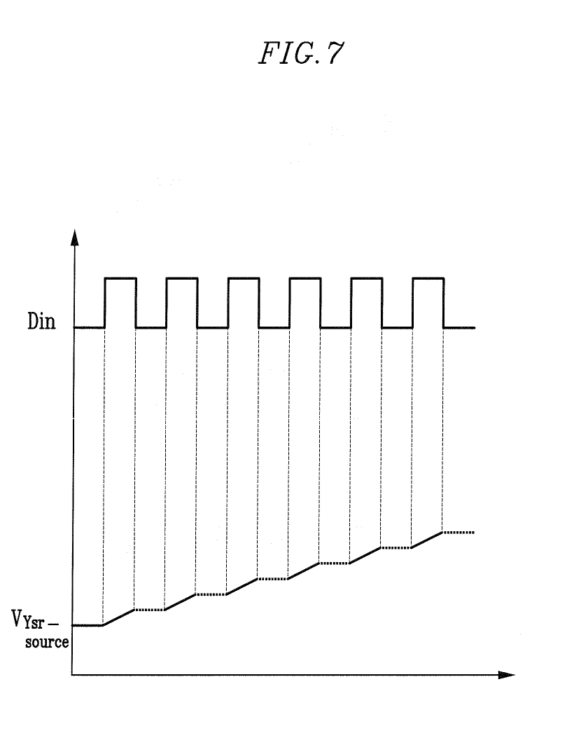

FIG. 7 is a diagram of the control signal Din and a source voltage of the switch Ysr of the gate driving circuit 440 of FIG. 5 in the rising period of the reset period according to an aspect of the invention.

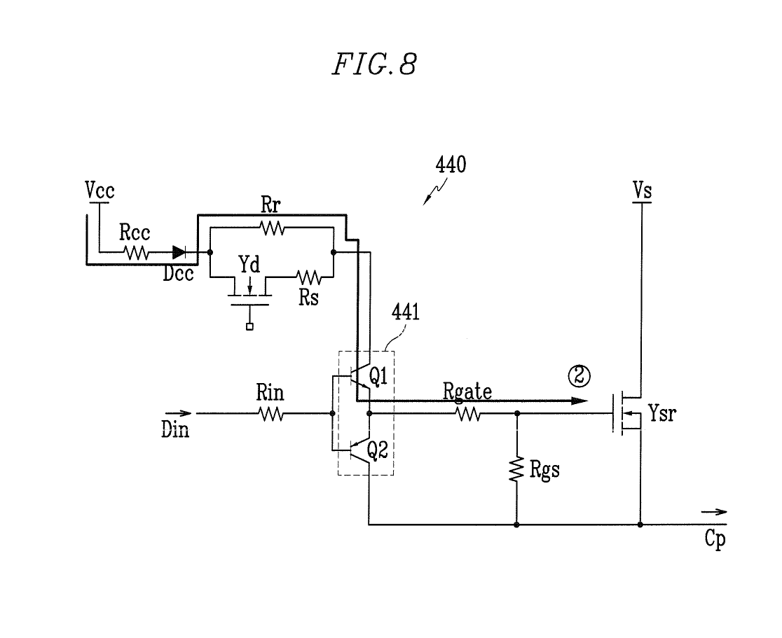

FIG. 8 is a diagram of a current path formed in the gate driving circuit 440 of FIG. 5 when the control signal Din is at a high level in the rising period of the reset period according to an aspect of the invention.

In the rising period of the reset period, the switch Yd is turned off and a control signal Din in which a high level and a low level repeatedly alternate with a short period is applied to the push-pull circuit 441.

As described above, in the sustain period, the control signal Din is maintained at the high level to apply the Vs voltage to the Y electrodes, and is maintained at the low level to apply the 0V voltage to the Y electrodes. As shown in FIG. 7, the control signal Din alternates between the high and low levels in the rising period of the reset period. This alternation of the high and low levels of the control signal Din causes a process of turning on the switch Ysr by the control signal Din having the high level and a process of turning off the switch Ysr by the control signal Din having the low level to be alternately repeated.

If the high level of control signal Din is applied to the push-pull circuit 441 while the switch Yd is turned off, the transistor Q1 is turned on and the transistor Q2 is turned off, thereby forming a current path \textcircled{2} including the Vcc power source, the resistor Rr, the transistor Q1, and the resistor Rgate as shown in FIG. 8. When the capacitor Cgs is charged up to a voltage exceeding the threshold voltage VT by a current flowing in the current path \textcircled{2}, the switch Ysr turns on. This forms a current path including the Vs power source, the switch Ysr, and the Y electrode, and causes a source voltage of the switch Ysr (see “Ysr-source” in FIG. 7) to increase. As a time it takes for the capacitor Cgs to charge up to a voltage exceeding the threshold voltage VT becomes greater than a predetermined period, a resistance value of the resistor Rr is set to be at least several tens of Ω so that a time between a turn-on and turn-off operation of the switch Ysr may be lengthened.

Thereafter, if the low level of control signal Din is applied to the push-pull circuit 441 while the switch Yd is turned off, the transistor Q2 is turned on and the transistor Q1 is turned off, thereby discharging the voltage of the capacitor Cgs between the gate and the source of the switch Ysr and turning the switch Ysr off. Thereafter, as shown in FIG. 7, the source voltage Ysr-source of the switch Ysr does not change.

In the rising period of the reset period, since the control signal Din applied to the push-pull circuit 441 has a relatively short period, the switch Ysr repeatedly turns on and off in a short period. Accordingly, while the switch Ysr is turned on, a voltage of the Y electrode rises, then while the switch Ysr is turned off, the voltage of the Y electrode does not change, and then when the switch Ysr is turned on again, the voltage of the Y electrode rises again. By repeating this process, the voltage of the Y electrode gradually increases by the Vs voltage to the (VscH+Vs) voltage shown in FIG. 2.

As described above, according to an aspects of the invention, the switch Ysr for connecting the power source for supplying the sustain voltage to the Y electrode is turned on in the sustain period to apply the sustain voltage to the Y electrode, and is repeatedly turned on and off in the rising period of the reset period to apply a voltage waveform that gradually increases by the sustain voltage to the Y electrode. Accordingly, a power source for supplying a voltage necessary for a reset rising waveform and a switch for applying the reset rising waveform to the Y electrode may be omitted. That is, an element having a high withstanding voltage and capacity that would normally be used as a switch for applying the reset rising waveform to the Y electrode can be omitted, making it possible to use a simple circuit reduce a manufacturing cost.

According to aspects of the invention, the number of power sources can be reduced and a switch having a high withstanding voltage and capacity can be omitted, so that a simple circuit can be implemented.

Although several embodiments of the invention have been shown and described, it would be appreciated by those skilled in the art that changes may be made in these embodiments without departing from the principles and spirit of the invention, the scope of which is defined in the claims and their equivalents.

What is claimed is:

1. A plasma display device comprising:
a plurality of electrodes;
a first switch having a first terminal connected to a first power source to supply a sustain voltage that is applied to the plurality of electrodes in a sustain period, and having a second terminal connected to the plurality of electrodes;
an amplifier having a first power terminal to which a first voltage to turn on the first switch is applied, a second power terminal to which a second voltage to turn off the first switch is applied, an input terminal to which a control signal is input, and an output terminal to output the first voltage to turn on the first switch or the second voltage to turn off the first switch, in response to the control signal;
a first resistor having a first terminal connected to the first power terminal of the amplifier, the first resistor having a first resistance value; and
a second switch having a first terminal connected to the first power terminal of the amplifier, the second switch being connected in parallel with the first resistor.

2. The plasma display device of claim 1, further comprising a second resistor having a first terminal connected to the second switch so that the second resistor is connected in series with the second switch, and the series connection of the second resistor and the second switch is connected in parallel with the first resistor;
wherein the second resistor has a second resistance value smaller than the first resistance value.

3. The plasma display device of claim 1, wherein the second terminal of the first switch is a source of the first switch;
wherein the first switch further has a gate; and
wherein the plasma display device further comprises:
a third resistor having a first terminal connected to the input terminal of the amplifier,
a fourth resistor connected between the output terminal of the amplifier and the gate of the first switch, and
a fifth resistor connected between the gate of the first switch and the second terminal of the first switch that is the source of the first switch.

4. The plasma display device of claim 1, wherein the first power terminal of the amplifier is connected to a second power source to supply the first voltage; and
wherein the second power terminal of the amplifier is connected to the second terminal of the first switch.

5. The plasma display device of claim 4, wherein the first switch further has a gate;
wherein the output terminal of the amplifier is connected to the gate of the first switch;
wherein the amplifier comprises:
an npn-type transistor having a collector connected to a junction point of the first resistor and the second switch via the first power terminal of the amplifier, an emitter connected to the gate of the first switch via the output terminal of the amplifier, and a base to which the control signal is applied via the input terminal of the amplifier, and
a pnp-type transistor having a collector connected to the second terminal of the first switch via the second power terminal of the amplifier, an emitter connected to the gate of the first switch via the output terminal of the amplifier, and a base to which the control signal is applied via the input terminal of the amplifier; and
wherein the npn-type transistor and the pnp-type transistor form a push-pull circuit.

6. The plasma display device of claim 1, further comprising a diode having an anode connected to a second power source to supply the first voltage, and having a cathode connected to a junction point of the first resistor and the second switch.

7. The plasma display device of claim 1, wherein the first switch maintains a voltage of the plurality of electrodes at the sustain voltage by turning on in the sustain period; and
wherein the first switch gradually increases a voltage of the plurality of electrodes from a positive third voltage to a fourth voltage that is a sum of the third voltage and the sustain voltage repeatedly turning on and off in a portion of a reset period.

8. The plasma display device of claim 7, wherein a current path including the second switch is formed by turning on the second switch in the sustain period.

9. The plasma display device of claim 7, wherein a current path including the first resistor is formed by turning off the second switch in the portion of the reset period.

10. The plasma display device of claim 9, wherein a period of the control signal in the portion of the reset period is shorter than a period of the control signal in the sustain period.

11. A driving apparatus of a plasma display device, the plasma display device comprising a plurality of electrodes, the driving apparatus comprising:
a first switch connected between the plurality of electrodes and a first power source to supply a sustain voltage that is applied to the plurality of electrodes in a sustain period, the first switch having a control terminal; and
a driving circuit of the first switch;
wherein the driving circuit comprises:
an amplifier having a first power terminal to which a first voltage is applied, a second power terminal to which a second voltage is applied, an input terminal to which a control signal is input, and an output terminal to output the first voltage or the second voltage in response to the control signal, the output terminal of the amplifier being connected to the control terminal of the switch,
a first resistor connected between a second power source to supply the first voltage and the first power terminal of the amplifier, and
a second switch and a second resistor connected in series with one another, the series connection of the second switch and the second resistor being connected in parallel with the first resistor between the second power source and the first power terminal of the amplifier;
wherein if the first voltage is output from the output terminal of the amplifier, the first switch turns on; and
wherein if the second voltage is output from the output terminal of the amplifier, the first switch turns off; and
wherein the first switch operates to apply the sustain voltage to the plurality of electrodes in the sustain period, and operates to apply a gradually increasing voltage to the plurality of electrodes in a portion of a reset period.

12. The driving apparatus of claim 11, further comprising a diode having an anode connected to the second power source to block a current from flowing to the second power source.

13. The driving apparatus of claim 11, wherein the first switch further has a first terminal connected to the plurality of electrodes; and
wherein the driving apparatus further comprises:
a third resistor having a first terminal connected to the input terminal of the amplifier,
a fourth resistor connected between the output terminal of the amplifier and the control terminal of the first switch, and
a fifth resistor connected between the first terminal of the first switch that is connected to the plurality of electrodes, and the control terminal of the first switch.

14. The driving apparatus of claim 11, wherein the first switch further has a first terminal connected to the plurality of electrodes;
wherein the driving apparatus further comprises a capacitor connected between the first power terminal of the amplifier and the second power terminal of the amplifier; and
wherein the second power terminal of the amplifier is connected to the first terminal of the first switch that is connected to the plurality of electrodes.

15. The driving apparatus of claim 11, wherein the first switch further has a first terminal connected to the plurality of electrodes; and
wherein the amplifier is a push-pull circuit comprising:
an npn-type transistor having a collector connected to a junction point of the first resistor and the second resistor via the first power terminal of the amplifier, an emitter connected to the output terminal of the amplifier, and a base to which the control signal is applied via the input terminal of the amplifier, and
a pnp-type transistor having a collector connected to the first terminal of the first switch via the second power terminal of the amplifier, an emitter connected to the output terminal of the amplifier, and a base to which the control signal is applied via the input terminal of the amplifier.

16. The driving apparatus of claim 11, wherein the first switch operates to gradually increase a voltage of the plurality of electrodes from a positive third voltage to a fourth voltage that is a sum of the third voltage and the sustain voltage by repeatedly turning on and off in the portion of the reset period.

17. The driving apparatus of claim 11, wherein a first current path including the second power source, the second switch, the second resistor, and the first power terminal of the amplifier is formed by turning on the second switch in the sustain period;
wherein a second current path including the second power source, the first resistor, and the first power terminal of the amplifier is formed by turning off the second switch in the portion of the reset period; and
wherein a current flowing in the first current path is greater than a current flowing in the second current path.

18. The driving apparatus of claim 17, wherein a period of the control signal in the portion of the reset period is shorter than a period of the control signal in the sustain period.

19. A driving method of a plasma display device, the plasma display device comprising a plurality of electrodes, and a first switch connected between the plurality of electrodes and a first power source to supply a sustain voltage to be applied to the plurality of electrodes in a sustain period, the first switch having a control terminal, the driving method comprising:
applying a first current to the control terminal of the first switch in the sustain period; and
discontinuously applying a second current having a current value smaller than a current value of the first current to the control terminal of the first switch in a portion of a reset period.

20. The driving method of claim 19, wherein the applying of a first current comprises continuously applying the first current to the control terminal of the first switch in the sustain period.

21. The driving method of claim 19, wherein the plasma display device further comprises:
a first resistor, and
a second resistor having a resistance value greater than a resistance value of the first resistor;
wherein a path of the first current comprises the first resistor; and
wherein a path of the second current comprises the second resistor.

22. The driving method of claim 19, wherein the discontinuously applying of a second current causes a voltage of the plurality of electrodes to gradually increase from a positive first voltage to a second voltage that is a sum of the first voltage and the sustain voltage.

23. A plasma display device comprising:
a plurality of electrodes;
a switch having a first terminal, a second terminal, and a control terminal, the first terminal being connected to a sustain voltage source to supply a sustain voltage to be applied to the electrodes in a sustain period of the plasma display device, the second terminal being connected to the electrodes; and
a driving circuit to apply a first current having a first current value to the control terminal of the switch in the sustain period, and to apply a second current having a second current value less than the first current value to the control terminal of the switch during a portion of a reset period of the plasma display device.

24. The plasma display device of claim 23, wherein the driving circuit applies the first current to the control terminal of the switch in the sustain period to control the switch to turn on in the sustain period to maintain a voltage of the electrodes at the sustain voltage; and
wherein the driving circuit discontinuously applies the second current to the control terminal of the switch in the portion of the reset period to control the switch to repeatedly turn on and off in the portion of the reset period to gradually increase a voltage of the electrodes from a positive first voltage to a second voltage that is a sum of the positive first voltage and the sustain voltage.
